(19) United States
(12) Patent Application Publication
(10) Pub. No.: US 2019/0360213 A1
(43) Pub. Date: Nov. 28, 2019

(54) PREASSEMBLED STRUCTURAL IMPACT PANEL

(71) Applicant: M-Tech Construction Technologies Inc., Doral, FL (US)

(72) Inventor: Alex Mendoza, Doral, FL (US)

(21) Appl. No.: 15/987,691

(22) Filed: May 23, 2018

(51) Int. Cl. E04F 13/075; E04F 13/077; E04F 13/08; E04F 13/14; E04F 11/18; E04B 2/88; B32B 7/12; B32B 9/00; B32B 27/30; B32B 17/06

(52) U.S. Cl. CPC E04F 13/075; E04F 13/077; E04F 13/0832; E04F 13/0866; E04F 13/142; E04F 11/1851; B32B 2419/00; B32B 7/12; B32B 9/005; B32B 27/306; B32B 17/06; E04F 2290/04; E04B 2/88

(57) ABSTRACT

The present invention is a cladded panel for architectural use to replace spandrel glass panels or aluminum panels that can still withstand high wind speeds. The cladded panel of the present invention is a three-layered panel formed by cladding a first porcelain layer, a polymeric interlayer and a second porcelain layer. In one form, first porcelain layer is cladded or baked to the polymeric interlayer and the polymeric interlayer is cladded or baked to second porcelain layer. Cladded panels when assembled to form an architectural structure provide high wind-resistance and insulation from external environment and also forms a durable and aesthetically appealing structure by hiding the unaesthetic elements within a structure at low cost.

### BACKGROUND OF THE INVENTION

### 1. Field of the Invention

The present disclosure relates to a panel for forming an architectural structure. More particularly, the present disclosure relates to a cladded panel that provides high wind resistance and insulation to an architectural structure and is aesthetic appealing at low cost.

### 2. Description of the Related Art

Architectural structures, like a building unit, houses, apartments or skyscrapers, require panels to withstand high wind pressure and insulate the interior of the building from the external environment. In many conventional architectural structures, for aesthetic appeal, glasses are used, however, such glasses, because of their brittle property, are susceptible to break. Hence, there is a need for a cladded panel that provides resistance to high wind, insulation from environment, is aesthetically appealing at less in cost and more durable.

Several designs for various panels have been designed in the past. None of them, however, include a low-cost and aesthetically appealing cladded panel for use in architectural structure and that is high wind resistance, durable and provides insulation from the external environment.

Applicant believes that a related reference corresponds to European patent EP0340607 filed by Construction Specialties Inc. for a panel wall system. The Construction Specialties Inc. reference discloses a panel wall system that is composed of a multiple rectangular panels arranged in closely spaced relation in columns and rows. However, the panel wall system disclosed by Construction Specialties Inc. is complex and does not explicitly mention of aesthetic appeal at low cost.

Another related application is U.S. Pat. No. 8,484,931 filed by James Hardie Technology Ltd. for an external and internal wall cladding system. The James reference discloses wall cladding and wall cladding system each comprising a plurality of panels. However, the James reference teaches of an embodiment requiring in which panels require a recess and hence makes it complex for manufacturing. Also, the wall cladding disclosed by James may not be aesthetically appealing at low cost along with resisting high wind pressure.

Other documents describing the closest subject matter provide for a number of more or less complicated features that fail to solve the problem in an efficient and economical way. None of these patents suggest the novel features of the present invention.

### SUMMARY OF THE INVENTION

It is an object of the present invention to provide a cladded panel for architectural use that withstands high wind resistance and is durable.

It is yet another object of the present invention to provide a cladded panel for architectural use that protects the internal environment of architecture from the external environment.

It is still another object of the present invention to provide a cladded panel for architectural use that is aesthetically appealing at low cost.

It is another object of the present invention to provide a cladded panel for architectural use that is formed of a polymeric interlayer that is cladded with/sandwiched between two porcelain tiles.

Further objects of the invention will be brought out in the following part of the specification, wherein detailed description is for the purpose of fully disclosing the invention without placing any limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents a perspective view of the present invention in its operating environment showing an architectural structure a portion of which is formed by assembly of cladded panels which are formed by a polymeric interlayer cladded with/sandwiched between two porcelain tiles and a window fitted therebetween.

FIG. 2 demonstrates of perspective view of a typical cladded panel showing a polymeric interlayer 30 sandwiched between porcelains tiles 20 and 40.

FIG. 3 shows an exploded view of a typical cladded panel.

FIG. 4 is a side view of a typical cladded panel.

### DETAILED DESCRIPTION OF THE EMBODIMENTS OF THE INVENTION

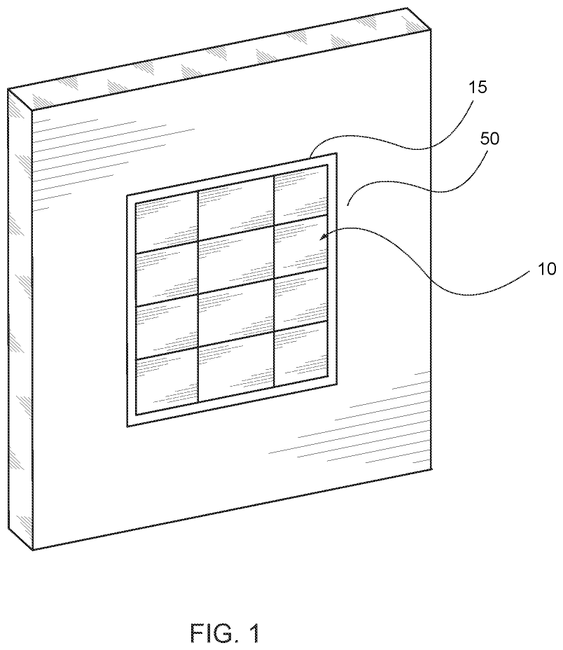

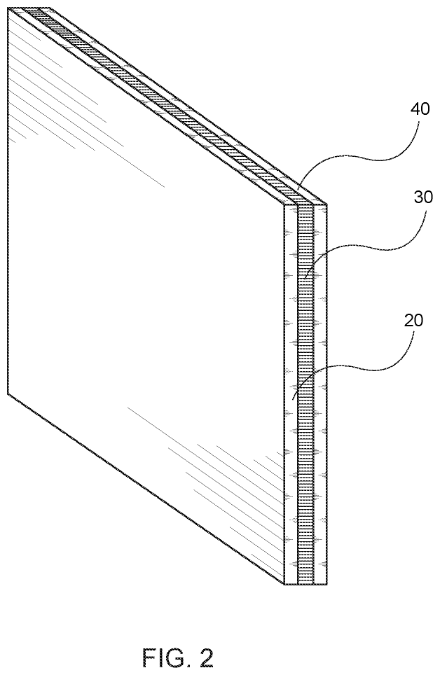

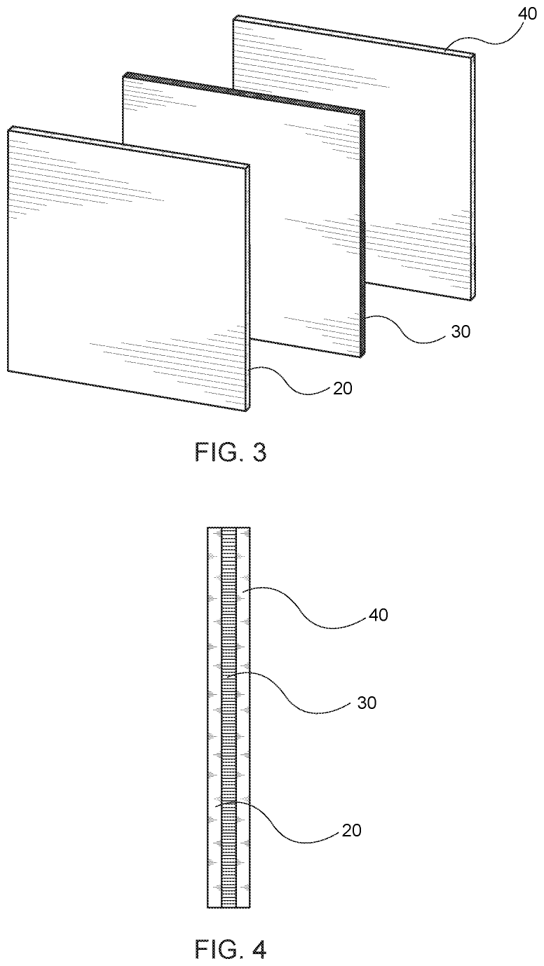

Referring now to the drawings, FIGS. 1-4, where the present invention is generally referred to with numeral 10, it can be observed that a plurality of cladded panels are arranged to form an architectural structure or a portion of an architectural structure, in accordance with one embodiment. Each cladded panel 10 is formed by assembly of a first porcelain layer 20, a polymeric interlayer 30 and a second porcelain layer 40.

As illustrated in FIG. 1, a number of cladded panels 10 are assembled together in an aluminum frame 15 (or frame of other like materials) to form a portion of a glass structural/wall 50. Cladded panels 10 framed in frame 15 are used instead of using conventional laminated impact glass (not illustrated in Figures). Presently, a structure 50 can include glass curtain walls separated by spandrel panels that hide the slabs and/or HVAC and/or other structural elements that are not aesthetically pleasing to see. Spandrel as an element to hide those components limits architects to particular colors and arrangements that can be configured onto a structure. The present invention provides a solution to these limitations placed upon architects by replacing the spandrel glass panel with an impact resistant porcelain panel that can come in various patterns and colors and resembles other building materials such as stone or marble. Each cladded panel 10 is formed by the assembly of first porcelain layer 20, a polymeric interlayer 30 and second porcelain layer 40. First porcelain layer 20 and second porcelain layer 40 is basically a porcelain tile that can be produced in various shapes, sizes, colors, and/or patterns. Use of porcelain tile provides advantage of durability, longevity and an enhanced aesthetic look as compared to conventional spandrel glass tiles. Porcelain tile can be decorated with various designs, line patterns, pictures and the like which makes porcelain tile more attractive and versatile. Porcelain tile can be produced in various shapes and sizes. Use of porcelain tile also provides advantage of being more impervious even when compared to tiles made of ceramics.

Polymeric layer 30 is an interlayer between first porcelain layer 20 and second porcelain layer 40. This interlayer provides more overall strength and makes the present invention impact resistant. The concept is similar to impact glass panels that sandwich a polymeric layer in between two glass panels so that the glass does not break off upon impact. Analogously, the polymeric layer in the present invention sandwiched between both porcelain tiles permits for the porcelain tiles to receive a blunt impact and not break off a structure, thereby maintaining all the benefits of impact glass while providing the newly added benefits of giving an architect many more design options.

In one depicted embodiment, polymeric layer 30 is cladded to first porcelain layer 20 by use of an adhesive layer 25 and second porcelain layer 40 by use of an adhesive layer 35. Polymeric layer 30 can also be baked onto the first and second porcelain layers. Though the present embodiment is described and illustrated with cladding of first porcelain layer 20, polymeric layer 30 and second porcelain layer 40 by use of adhesive layers 25 and 35, however, the present invention is not limited to cladding by use of adhesives and other cladding or joining means that can clad/join first porcelain layer 20 with polymeric layer 30 and polymeric layer 30 with second porcelain layer 40 are within the scope of the present disclosure.

Cladded panel 10 thus can be used for various architectural structure purposes that complement window systems of a given structure to cover elements that should be concealed for aesthetic purposes. Further, enclosed architectural structure formed of assembling cladded panels 10 insulating internal environment from the external environment (unlike glass) because it's non-porous/impervious and blocks out the sun's heat. Also, cladded panels 10 are more durable and less brittle than glass.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A preassembled structural panel, comprising: an impact resistant panel assembly including a first porcelain panel, a second porcelain panel, and a polymeric interlayer sandwiched between said first and second porcelain panel, said polymeric interlayer is made of polyvinyl butyral.

2. The preassembled structural panel of claim 1 wherein said polymeric interlayer is baked onto said first and second porcelain panels.

3. The preassembled structural panel of claim 1 wherein said impact resistant panel assembly is included within a window system configuration on a structure having an outer window and an inner window, wherein said impact resistant panel assembly is placed between said inner and outer window and is placed in vertical or horizontal configurations along the facade of a building.

4. The preassembled structural panel of claim 1 wherein said first porcelain panel has a different design than said second porcelain panel.

5. The preassembled structural panel of claim 1 wherein said first porcelain panel has a different color than said second porcelain panel.

6. The preassembled structural panel of claim 1 wherein said first porcelain panel has an identical shape to said second porcelain panel.

7. The preassembled structural panel of claim 1 wherein first porcelain panel and said second porcelain panel are impervious.

8. (canceled)

9. (canceled)

10. The preassembled structural panel of claim 1 wherein said first and second porcelain panel includes a length and width, said polymeric layer extends along entire said length and width.

11. The preassembled structural panel of claim 1 wherein said polymeric layer fuses said first and second porcelain panels together.

12. (canceled)

13. (canceled)

14. The preassembled structural panel of claim 1 wherein said polymeric layer includes ethylene-vinyl acetate.
